(19) United States
(12) Patent Application Publication
(10) Pub. No.: US 2010/0141761 A1
(43) Pub. Date: Jun. 10, 2010

(54) METHOD AND SYSTEM FOR STABILIZING VIDEO IMAGES

(76) Inventor: Kenneth McCormack, Albany, OR (US)

Correspondence Address: PATRICK W. RASCHE (22697);ARMSTRONG TEASDALE LLP, ONE METROPOLITAN SQUARE, SUITE 2600, ST. LOUIS, MO, 63102-2740, US

(21) Appl. No.: 12/330,191

(22) Filed: Dec. 8, 2008

(51) Int. Cl. H04N 7/18; H04N 5/262

(52) U.S. Cl. 348/143; 348/240.3; 348/E07.085; 348/E05.055

(57) ABSTRACT

A method and system for video camera assembly are provided. The video camera assembly includes at least one of a pan mechanism rotatable about a pan axis and a tilt mechanism rotatable about a tilt axis. The video camera assembly further includes an accelerometer coupled to the at least one of the pan mechanism and the tilt mechanism and a controller communicatively coupled to the at least one of the pan motor and the tilt motor, the controller further communicatively coupled to the accelerometer, and the video camera. The controller is configured to receive acceleration data from the accelerometer, determine an oscillatory displacement of the video camera using the received acceleration data, generate a motor angular modulation signal, and apply the motor angular modulation signal to at least one of the pan motor and the tilt motor to reduce the oscillatory displacement of the video camera.

### BACKGROUND OF THE INVENTION

The field of the invention relates generally to video surveillance systems and, more particularly, to a method and system configured to stabilize video images.

At least some known video surveillance systems include one or more video camera assemblies that typically include a video camera mounted in a housing along with a pan, tilt, and zoom (PTZ) assembly. The PTZ permits controlling a movement of the camera to align a viewing area of the camera with an object of interest or location of interest. The zoom portion of the mechanism may be used to adjust a field of view of the camera. The housing protects the camera from the environment in the location where the camera and PTZ assembly are mounted.

Video camera assemblies such as security cameras are installed in various manners. Typical pendent mount and pole installation of cameras have the potential to have undesirable oscillation. Vibrations characterized as “swaying” which, with the z-axis pointing vertically, occurs along the x and y plane of the camera installation. Many environmental forces can cause swaying. Generally, each installation is associated with frequencies at which the camera will oscillate. For example, some known video camera assemblies have an axially un-centered weight distribution in one or both pan and tilt axes. This offset weight may excite the natural frequencies of the oscillation of the video camera assembly when the camera is started, stopped, or moved quickly. The settling time for the naturally occurring frequencies can be rather large and in some cases may never decay resulting in permanent oscillations on the observed video. When a video camera assembly oscillates, the displayed image wobbles making the image difficult for a user to watch. Other modes of oscillation may be present due to wind, or mechanical equipment operating nearby.

Image stabilization techniques generally include two methods, mechanical stabilization, and image manipulation. Mechanical stabilization includes adding counterweights, adding additional weight, isolating the camera from a vibration source and/or gimballing the camera. Image manipulation includes cropping and electronically repositioned the image on the display to counter the oscillation. However, such methods tend to mask the oscillation rather than eliminate the source of oscillation.

### BRIEF SUMMARY OF THE INVENTION

In one embodiment, a video camera assembly includes at least one of a pan mechanism rotatable about a pan axis and a tilt mechanism rotatable about a tilt axis. The pan mechanism includes a pan motor and a pan position encoder, the tilt mechanism includes a tilt motor and a tilt position encoder. The video camera assembly also includes a video camera coupled to the at least one of the pan mechanism and the tilt mechanism. The video camera is rotatable about at least one of the pan axis and the tilt axis and the video camera subject to an oscillatory displacement due to at least one of a vibrational excitation from a source external to the video camera assembly and a source internal to the video camera assembly. The video camera assembly further includes an accelerometer coupled to the at least one of the pan mechanism and the tilt mechanism and a controller communicatively coupled to the at least one of the pan motor and the tilt motor, the controller further communicatively coupled to the accelerometer, and the video camera. The controller is configured to receive acceleration data from the accelerometer, determine an oscillatory displacement of the video camera using the received acceleration data, generate a motor angular modulation signal, and apply the motor angular modulation signal to at least one of the pan motor and the tilt motor to reduce the oscillatory displacement of the video camera.

In another embodiment, a method of operating a video camera assembly is provided. The video camera assembly includes a video camera, an accelerometer, and at least one of a pan mechanism and a tilt mechanism, the pan mechanism includes a pan motor and a pan axis encoder and the tilt mechanism includes a tilt motor and a tilt axis encoder. The method includes determining an oscillatory displacement of the video camera using the accelerometer and applying a correction signal to at least one of the pan motor and the tilt motor that opposes the oscillatory displacement.

In yet another embodiment, a video system includes an enclosure including an accelerometer and a video camera assembly positioned at least partially within the enclosure. The video camera assembly includes a video camera and at least one of a pan mechanism and a tilt mechanism. The pan mechanism includes a pan motor and a pan position encoder. The tilt mechanism includes a tilt motor and a tilt position encoder. The video system also includes a controller communicatively coupled to the video camera assembly and the accelerometer and configured to receive video data from the video camera and analyze the video data from the video camera to determine differences between sequential frames of the video data. The controller is further configured to determine displacement vectors from the analyzed video data, the displacement vectors representing a frequency and phase of motion of the video camera and transmit the determined displacement vectors to a gain adjustment module.

### BRIEF DESCRIPTION OF THE DRAWING

FIGS. 1-8 show exemplary embodiments of the method and system described herein.

FIG. 1 is a schematic view of an embodiment of a video surveillance system constructed in accordance with the principles of the present invention;

FIG. 2 is a perspective view of a plurality of images such as may be acquired by the video camera shown in FIG. 1;

FIG. 3 is a graph of deflections of the enclosure shown in FIG. 1 in response to a 60 Hz excitation;

FIG. 4 is a graph of the phase of oscillations of the enclosure shown in FIG. 1 in response to a 60 Hz excitation;

FIG. 5 is schematic representation of a reference frame for video camera assembly shown in FIG. 1;

FIG. 6 is a schematic block diagram of a vibration compensation circuit of video surveillance system in accordance with an embodiment of the present invention;

FIG. 7 is a schematic block diagram of the geometry of video camera assembly during oscillatory displacements in accordance with an exemplary embodiment of the present invention; and

FIG. 8 is a flow chart of an exemplary method of operating a video camera assembly that includes a video camera, an accelerometer, and at least one of a pan motor and a tilt motor.

### DETAILED DESCRIPTION OF THE INVENTION

The following detailed description illustrates embodiments of the invention by way of example and not by way of limitation. The description clearly enables one skilled in the art to make and use embodiments of the invention, describes several embodiments, adaptations, variations, alternatives, and uses of the invention, including what is presently believed to be the best mode of carrying out the invention. The invention is described as applied to a preferred embodiment, namely, stabilizing video images. However, it is contemplated that embodiments of the present invention has general application to stabilizing other equipment driven by motors and actuators in industrial, commercial, and residential applications.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

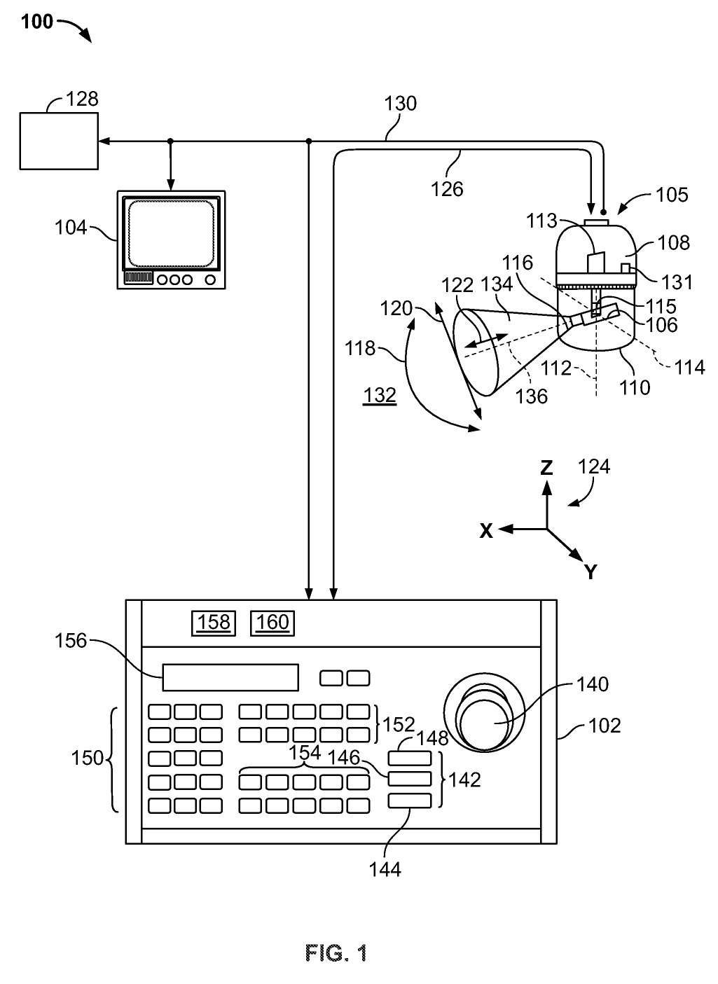

FIG. 1 is a schematic view of an exemplary video surveillance system 100 in accordance with an embodiment of the present invention. Video surveillance system 100 includes a controller 102, a display monitor 104, and a video camera assembly 105. Typically, video camera assembly 105 comprises a video camera 106 housed in an enclosure 108, which has a dome 110 that protects video camera 106 from the environment. In one embodiment, dome 110 is tinted to allow video camera 106 to acquire images of the environment outside of enclosure 108 and simultaneously prevent individuals in the environment being observed by video camera 106 from determining the orientation of video camera 106. In various alternative embodiments, dome 110 is not tinted. In the exemplary embodiment, video camera 106 is configured to pan horizontally about a vertical axis 112, tilt vertically about a horizontal axis 114, and control a lens assembly 116 to cause video camera 106 to zoom. For example, video camera assembly 105 includes a pan mechanism 113 and a tilt mechanism 115. Pan mechanism 113 includes a pan motor (not shown) and a pan position encoder (not shown). Tilt mechanism 115 includes a tilt motor (not shown) and a tilt position encoder (not shown). The encoders determine an angular position of the associated pan or tilt motor to generate position signals that are used with a zoom setting to determine an area in the field of view of video camera 106. Panning movement of video camera 106 is represented by an arrow 118, tilting movement of video camera 106 is represented by arrow 120, and the changing of the focal length of lens assembly 116 of video camera 106, i.e., zooming, is represented by arrow 122. As shown with reference to a coordinate system 124, a panning motion may track movement along an x-y plane and a tilting motion may track movement with respect to the z-axis. Signals representing commands to control such capabilities are transmitted from controller 102 through a control/data line 126. Image data signals are transmitted from video camera 106 to display monitor 104, a storage device 128, and to controller 102 through a video or data network 130. In an alternative embodiment, image data signals are transmitted from video camera 106 to controller 102 through control/data line 126. One or more accelerometers 131 are coupled to enclosure 108 such that the plane created by the x and y-axis on the device is normal to the pan rotation axis. In the exemplary embodiment, accelerometer 131 is not attached to tilt mechanism 115, rather accelerometer 131 is coupled to enclosure 108. In various embodiments, accelerometer may be a two-channel accelerometer.

Lens assembly 116 views an area of a location 132, which may be remote from controller 102 and is in a field of view 134 and along a viewing axis 136 of lens assembly 116. Images of location 132 that pass through lens assembly 116 are converted by video camera 106 into an electrical video signal, which is transmitted to display monitor 104. As used herein, an electrical video signal may an analog video signal or may be a digital video signal.

In an exemplary embodiment, controller 102 includes an X-Y control joystick 140 that is used to generate pan and tilt commands. A plurality of rocker-type switches 142 are used to control various camera functions. For example, a switch 144 controls a camera zoom function, a switch 146 controls a focus function, and a switch 148 controls an iris of lens assembly 116. In an alternative embodiment, joystick 140 includes a twist actuation that is used to control the zoom of video camera 106. Joystick 140 may also incorporate triggers and/or buttons to facilitate operating various controls associated with video surveillance system 100. Controller 102 also includes a numeric keypad 150 for entering numbers and values. In an alternative embodiment, controller 102 may include an alpha or alphanumeric keypad (not shown) for entering text as well as numbers. Controller 102 further includes a plurality of preset switches 152 that may be programmed to execute macros that automatically control the actions of video camera 106 and/or lens assembly 116. A plurality of buttons 154 may be used, for example, for predetermined control functions and/or user-defined functions, for example, a camera selection in a multi-camera video surveillance system. A display 156 may be used to display a status of video surveillance system 100 or may be used to display parameters associated with a selected video camera 106.

In operation, a processor 158 receives programmed instructions, from software, firmware, and data from memory 160 and performs various operations using the data and instructions. In one embodiment, processor 158 is located within controller 102. In various other embodiments, processor 158 is located remotely from controller 102. Processor 158 may include an arithmetic logic unit (ALU) that performs arithmetic and logical operations and a control unit that extracts instructions from memory 160 and decodes and executes them, calling on the ALU when necessary. Memory 160 generally includes a random-access memory (RAM) and a read-only memory (ROM), however, there may be other types of memory such as programmable read-only memory (PROM), erasable programmable read-only memory (EPROM) and electrically erasable programmable read-only memory (EEPROM). In addition, memory 160 may include an operating system, which executes on processor 158. The operating system performs basic tasks that include recognizing input, sending output to output devices, keeping track of files and directories and controlling various peripheral devices.

The term processor, as used herein, refers to central processing units, microprocessors, microcontrollers, reduced instruction set circuits (RISC), application specific integrated circuits (ASIC), logic circuits, and any other circuit or processor capable of executing the functions described herein. Memory 160 may include storage locations for the preset macro instructions that may be accessible using one of the plurality of preset switches 142.

As used herein, the terms “software” and “firmware” are interchangeable, and include any computer program stored in memory for execution by processor 158, including RAM memory, ROM memory, EPROM memory, EEPROM memory, and non-volatile RAM (NVRAM) memory. The above memory types are exemplary only, and are thus not limiting as to the types of memory usable for storage of a computer program.

In various embodiments, processor 158 and memory 160 are located external to video camera 106 such as in controller 102 or in a PC or other standalone or mainframe computer system capable of performing the functions described herein.

In an exemplary embodiment, video surveillance system 100 is a single camera application, however, various embodiments of the present invention may be used within a larger surveillance system having additional cameras which may be either stationary or moveable cameras or some combination thereof to provide coverage of a larger or more complex surveillance area. In an alternative embodiment, one or more video recorders (not shown) are connected to controller 102 to provide for recording of video images captured by video camera 106 and other cameras in video surveillance system 100.

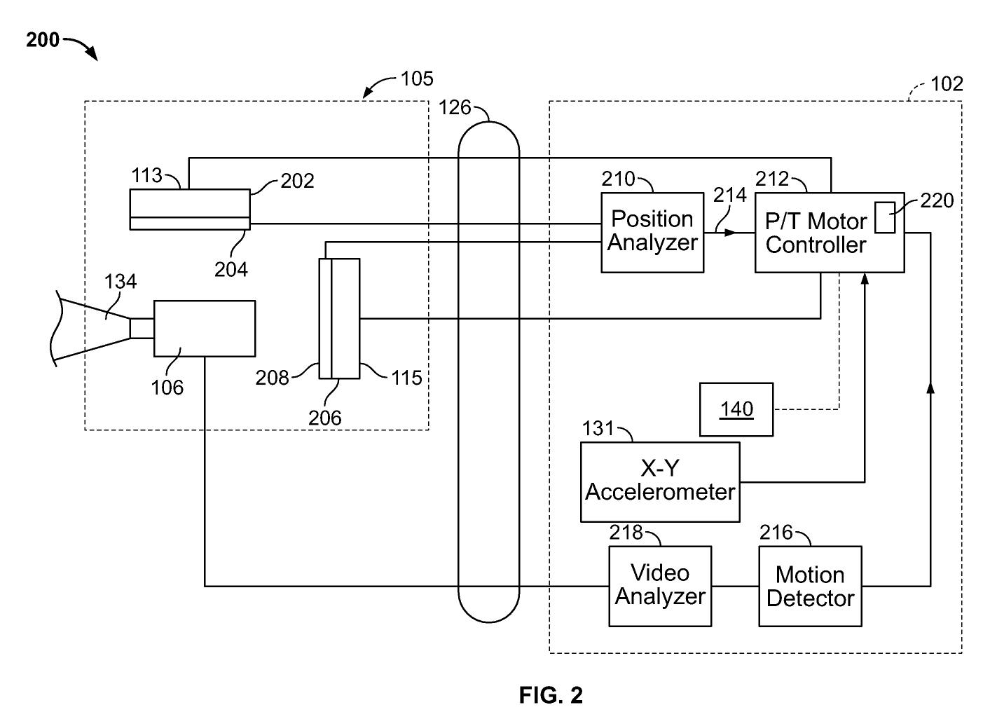

FIG. 2 is a schematic view of a portion 200 of video surveillance system 100 in accordance with an embodiment of the present invention. In the exemplary embodiment, video surveillance system 100 includes video camera assembly 105, pan mechanism 113, and tilt mechanism 115 communicatively coupled to controller 102 through control/data line 126. Pan mechanism 113 includes a pan motor 202 and a pan position encoder 204. Tilt mechanism 115 includes a tilt motor 206 and a tilt position encoder 208. Video camera 106 is mechanically coupled to pan mechanism 113 and tilt mechanism 115 and controller 102 is configured to generate and transmit control signals to pan motor 202 and tilt motor 206 to control field of view 134 of camera 106.

A position analyzer 210 is communicatively coupled to encoders 204 and 208 and is configured to receive signals relative to the angular position of encoders 204 and 208. Position analyzer 210 is further configured to transmit signals relative to the angular position of encoders 204 and 208 to a pan/tilt motor controller 212 through position feedback line 214. Pan/tilt motor controller 212 combines the feedback signals from position analyzer 210 with a motor position command signal from a position selector, such as joystick 140 and a motion feedback signal from a motion detector 216. A video analyzer 218 receives video signals from video camera 106 and processes the video signals for display and recording and further processing by at least motion detector 216.

In an exemplary embodiment, video camera assembly 105 includes an axially un-centered weight distribution along both vertical pan axis 112 and horizontal tilt axis 114. This offset weight excites the natural frequencies of oscillation of video camera assembly 105 is at rest and subject to external vibration or when pan mechanism 113 or tilt mechanism 115 is started, stopped, or moved quickly. In one embodiment, pan mechanism 113 or tilt mechanism 115 is considered to be moved quickly when the rotational velocity exceeds 60 degrees/second. In an alternative embodiment, pan mechanism 113 or tilt mechanism 115 is considered to be moved quickly when their rotational velocity exceeds 120 degrees/second. The settling time for the naturally occurring frequencies can be rather large and in some cases may never decay resulting in permanent oscillations on the observed video images. The offset weight distribution in each axis 112 and 114 can be used to the advantage of the system however. During installation or anytime after installation a user may operate pan motor 202 and/or tilt motor 206 for a predetermined time. For example, pan motor 202 and/or tilt motor 206 may be operated for a relatively short time to intentionally generate short a burst of oscillations of video camera assembly 105. The burst of oscillation is designed to be multi-modal in frequency content and is swept through the expected range of natural frequencies of the recommended installation methods. A short period follows each self-generated oscillation burst during which the respective motor is placed into a coast mode and the respective motor's associated encoder captures residual oscillations of video camera assembly 105. Alternatively, the oscillations are determined from features in the video images. Regardless of how determined, the oscillations are analyzed and an appropriate filter 220 is selected or computed to minimize the excitation of the natural frequencies of video camera assembly 105 during normal operation. In one exemplary embodiment filter 220 comprises a band-reject filter (BRF) that passes low frequencies below the lower cut-off frequency and passes high frequencies above the upper cut-off frequency. The BRF attenuates the signal whose frequency falls in the frequency band between the lower cut-off frequency and the upper cut-off frequency. A notch filter is a band-reject filter with a narrow stopband or high Q factor. A band-reject filter can also be fabricated by summing the responses of the low-pass and high-pass filters. In an exemplary embodiment, filter 220 includes filter parameters that define the output characteristics of filter 220. For example, parameters of filter 220 that define the operation of filter 220 include a gain, a center frequency, and a frequency bandwidth.

In operation, video analyzer 218 analyzes the video signals from video camera 106 to determine a harmonic content of the motion in field of view 134. The harmonic content of the video signals may be generated by an oscillation of video camera 106 when video camera assembly 105 is moved from one commanded position to another.

In one embodiment, for example, a first frame and a subsequent second frame of the video signal from video camera 106 are compared and velocity vectors determined for registered points in each of the frames. Motion vectors are determined for subsequent pairs of frames and the motion vectors may be plotted. The harmonic content of the motion in field of view 134 is determined from the determined motion vectors. In one embodiment, the filter parameters of filter 220 are adaptively determined and applied to pan motor 202 and tilt motor 206 through controller 212. The motion commands are modified by the operation of the determined parameters, substantially preventing the oscillation. In another embodiment, a motion control signal is generated that is phase-shifted, for example, shifted approximately 180° out of phase with the commanded position signal such that oscillatory motion commands are substantially canceled by the motion control signal that is 180° out of phase.

In another embodiment, video camera assembly 105 includes video camera 106 and at least one of pan mechanism 113 and tilt mechanism 115. Pan mechanism 113 includes pan motor 202 and pan position encoder 204 and tilt mechanism 115 includes tilt motor 206 and tilt position encoder 208. An oscillation of video camera assembly 105 is determined using encoders 204 and/or 208, or the video images generated from video camera 106. A signal generated by controller 102 is transmitted to at least one of pan motor 202 and tilt motor 206. The generated signal is configured to oppose the oscillation video camera assembly 105 as determined from at least one of pan position encoder 204 and tilt position encoder 208 and applied to at least one of pan motor 202 and tilt motor 206 such that the oscillation is facilitated being reduced.

The oscillation may be determined from a predetermined movement of video camera assembly 105. The predetermined movement may be a short burst of movement generating using pan motor 202 or tilt motor 206, deenergizing power to pan motor 202 and tilt motor 206 to permit video camera assembly 105 coasts to a substantially stationary position, and analyzing an output of at least one of the pan position encoder 204 and tilt position encoder 208 to determine the oscillations of the video camera assembly during coasting. Alternatively, determining the oscillation of video camera assembly 105 can occur each time the position of video camera assembly 105 is changed by including a period of coasting during each movement of video camera assembly 105.

In one embodiment, filter 220 is applied to the power supplied to pan motor 202 and/or tilt motor 206 during subsequent motor operation. Using an analysis of the power supplied, the oscillatory excitation may be reduced during the subsequent motor operation. At any time, characteristics of the oscillation may be determined and new filter parameters determined and applied to the power supplied to pan motor 202 and/or tilt motor 206.

Filter 220 may be embodied in software, firmware, and/or hardware in controller 102. In the exemplary embodiment, filter 220 comprises a notch filter or a band reject filter. When the oscillation of video camera assembly 105 is determined, a parameter that defines the operation of filter 220 may be determined to counter the effects of the oscillation on the video images generated by video camera 106. The parameters may include center frequency, bandwidth, attenuation, and filter Q.

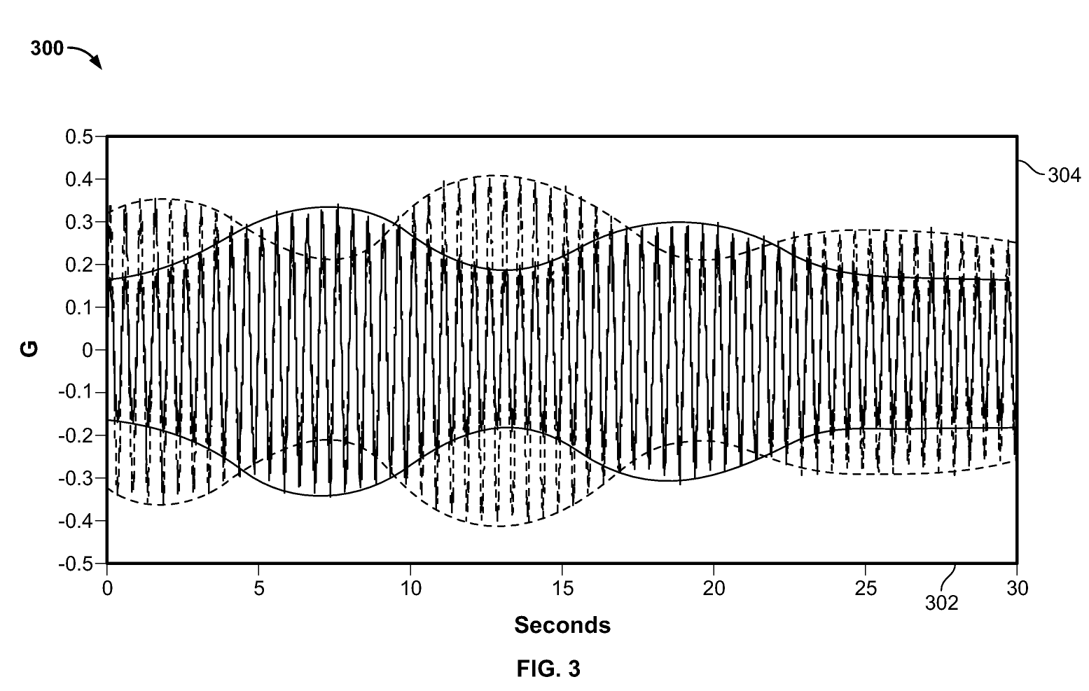

FIG. 3 is a graph 300 of deflections of enclosure 108 (shown in FIG. 1) in response to a 60 Hz excitation. In the exemplary embodiment, graph 300 includes an x-axis 302 graduated in units of time and a y-axis 304 graduated in units of displacement. Graph 300 includes a trace 306 of an exemplary response in the x direction of enclosure 108 and a trace 308 of an exemplary response in the y direction of enclosure 108. A mixture of the two degrees of freedom (x,y) determines the direction of the primary mode of oscillation. In an exemplary embodiment, only the primary mode of oscillation is canceled using controller 102. In an alternative embodiment, both modes of oscillation are canceled using controller 102.

The data collected includes acceleration deviations from a nominal rest position. The rest position is position of enclosure 108 when it is not experiencing oscillations. When oscillations are occurring, the rest position can be derived from acceleration data as the zero-crossing of the acceleration magnitude.

The highest acceleration, corresponding to the peaks in acceleration data, occurs at the largest positional deviation. Accordingly, the peaks of the acceleration are also the peaks of the position deflection. In general, with harmonic oscillations, the position deflection is proportional to the negative of the acceleration. This fact is used in the control loop for oscillation abatement.

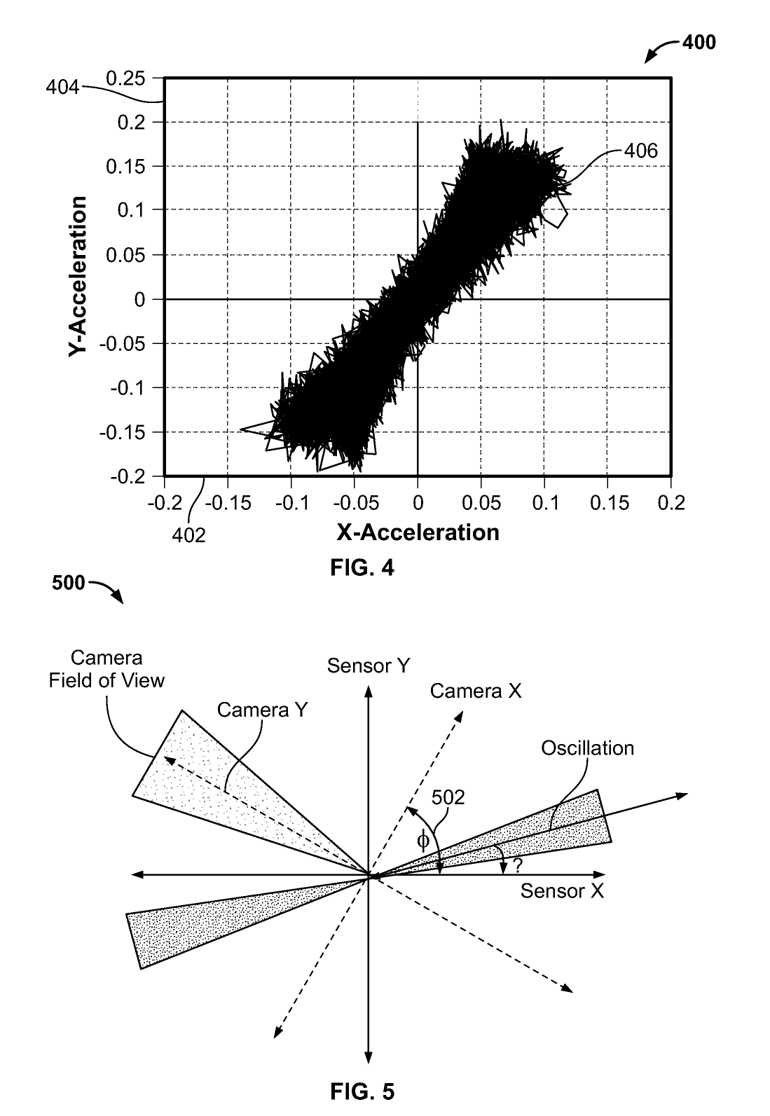

FIG. 4 is a graph 400 of the phase of oscillations of enclosure 108 (shown in FIG. 1) in response to a 60 Hz excitation. In the exemplary embodiment, graph 400 includes an x-axis 402 graduated in units of acceleration and a y-axis 404 graduated in units of acceleration. The X-Y acceleration of enclosure 108 can be plotted and interpreted in a phase plot. Graph 400 includes a trace 406 of an exemplary response in the y-direction as a function of acceleration in the x direction of enclosure 108.

FIG. 5 is schematic representation of a reference frame 500 for video camera assembly 105 (shown in FIG. 1). In the exemplary embodiment, video camera assembly 105 includes reference frame 500 relative to the x-y acceleration plane of the housing. Reference frame 500 can be rotated through an angle 502 with respect to the x-y acceleration reference frame due to the pan rotation. By convention, the x-axis of this camera reference plane is the lateral motion of the camera and is associated with the pan direction. The y-axis of this camera reference plane is the vertical motion of the camera or the tilt axis. A projection mapping, using simple trigonometry, is used to project the component of acceleration from the x-y housing plane to the camera reference frame. This projection is dependent on the pan angle and tilt angle with respect to the reference frame. For the tilt axis, two projections are used. One for projecting the housing acceleration reference frame into the camera reference frame. A second for projecting compensation of the tilt. After projections of housing acceleration are computed, a value for the horizontal acceleration of the video produced in the camera and the vertical acceleration of the video produced in the camera can be used for control purposes in controller 102.

The vibration of enclosure 108 also causes the video captured by video camera assembly 105 to vibrate. With video camera assembly 105 mounted on a pan mechanism 113 and/or tilt mechanism 115 that includes a pan motor 202 having a response that is fast and accurate enough, counter-rotating video camera assembly 105 via pan motor 202 to match the inverse of the oscillatory displacement tends to reduce the vibration of the video captured by a perceived. In the exemplary embodiment, the compensation frequency of modulation of pan motor 202 matches the vibration frequency of the housing. The amplitude of the compensation modulation is dependent on a distance the object being viewed from pan motor 202. A closer object requires a larger compensation swing. Farther objects require smaller compensating swings. In all cases, enclosure 108 has two degrees of freedom in vibration compensation. Pan motor 202 is used to compensate for horizontal motion. Tilt motor 206 is used to compensate for vertical motion. A combination of the compensation in vertical axis 112 and horizontal axis 114 is used to cancel vibration or oscillatory displacements in any direction.

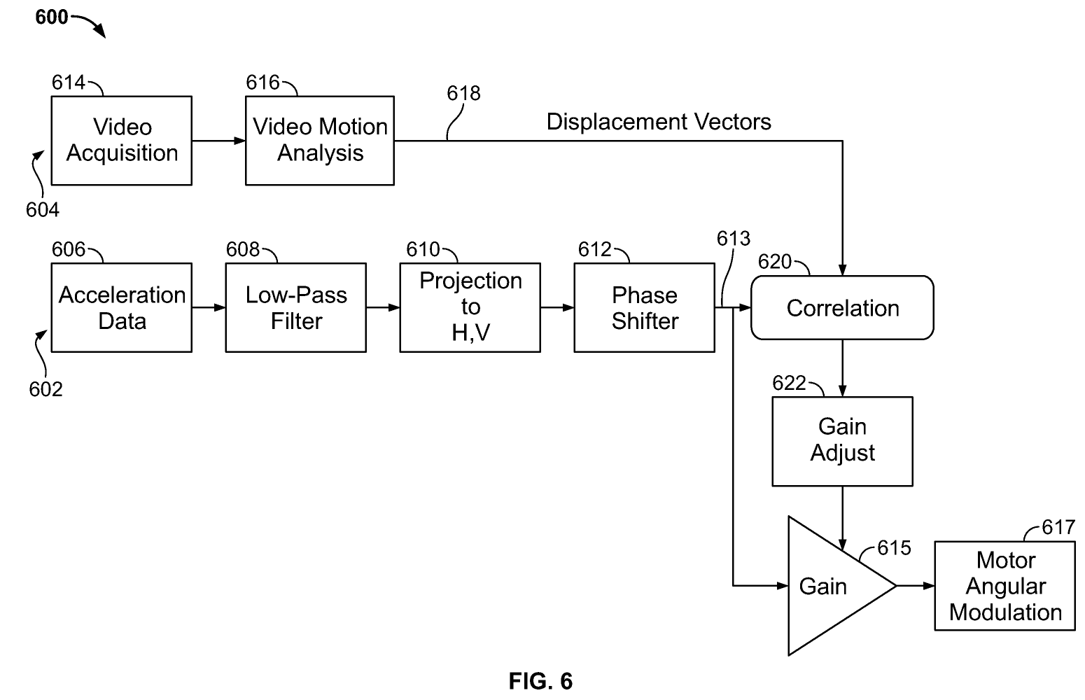

FIG. 6 is a schematic block diagram of a vibration compensation circuit 600 of video surveillance system 100 in accordance with an embodiment of the present invention. In the exemplary embodiment, vibration compensation circuit 600 includes an acceleration data processing path 602 and a video acquisition processing path 604.

Acceleration data processing path 602 includes a low pass filter 606 that is applied to acceleration data 608 collected from accelerometer 131 (shown in FIG. 1) to reduce noise that may be present in acceleration data 608. Acceleration data 608 is projected to the video plane using a projection module 610. The projected data is then phase shifted by a phase shifter 612. In the exemplary embodiment, the phase is shifted by approximately 180 degrees. In an alternative embodiment, the phase may be shifted by an amount other than 180 degrees. The resulting phase inverted acceleration data 613 is proportional to the oscillatory motion of enclosure 108 and video camera assembly 105 and is transmitted a gain module 615. Gain module 615 generates a motor angular modulation signal 617 that is applied to pan motor 202 and/or tilt motor 206.

A video acquisition system 614 acquires video data that is transmitted to a motion analysis module 616. Motion analysis module 616 evaluates sequential frames of the video data to determine if there is oscillatory motion in the video data by discerning differences between sequential frames. An output 618 of motion analysis module 616 comprises a series of displacement vectors that indicate the frequency and phase of motion of enclosure 108 and video camera assembly 105. The displacement vectors are normalized so that the size of the displacement is not influenced by the distance the object is from the camera lens. However, a weighting factor is added which places emphasis on vectors derived from the center of the video screen. This emphasis is used to force vibration compensation circuit 600 to minimize vibration effects in the center of the captured video.

Displacement vectors 618 from motion analysis module 616 and phase inverted acceleration data 613 are directed as inputs to a correlation module 620. If a positive correlation between displacement vectors 618 and phase inverted acceleration data 613 is detected then a compensation gain module 622 adjusts the compensation gain upwards. If a negative correlation is detected between displacement vectors 618 and phase inverted acceleration data 613 then the compensation gain is adjusted downwards. If no correlation exists then the gain is left unchanged. In general, the gain is increased proportional to the correlation. Some hysteresis and filtering is applied for control stability.

Positive correlation means that the amplitude of the compensating motor angular modulation needs to be increased. Negative correlation indicates that the compensating amplitude modulation is too high. In this last case the modulation is high enough that it is the cause of the video vibration. In either case the modulation carrier is phase inverted acceleration data 613. The amplitude of the carrier is based on the gain as described. If there is no vibration detected with the accelerometer then the gain is set to zero. Feedback is achieved by subsequent analysis of the video. A change in the gain up or down based on observed correlation converges to produce a gain factor appropriate for the current video field of view.

When a field of view of video camera assembly 105 is changed through direct zoom changes or pan/tilt position changes, the gain factor is reset to zero and the system reacquires the compensation gain if needed.

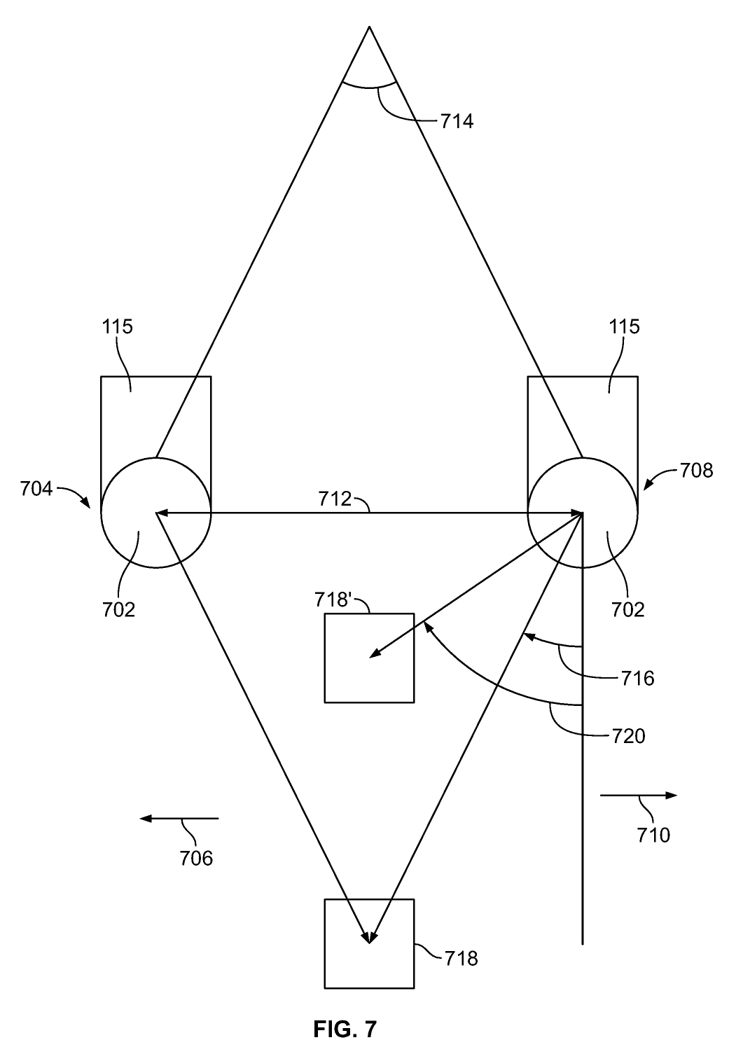

FIG. 7 is a schematic block diagram of the geometry of video camera assembly 105 during oscillatory displacements in accordance with an exemplary embodiment of the present invention. In the exemplary embodiment, a lens 702 of lens assembly 116 (shown in FIG. 1) is illustrated in a first position 704 representing the farthest extent of travel of lens assembly 116 in a first direction 706. Lens 702 of lens assembly 116 (shown in FIG. 1) is also illustrated in a second position 708 representing the farthest extent of travel of lens assembly 116 in a second direction 710. A distance 712 represents the total displacement of lens assembly 116 between first position 704 and second position 708. An angle 714 represents an angle of deflection of enclosure 108 and is related to distance 712. An angle 716 represents an angle in which pan motor 202 and/or tilt motor 206 is rotated to compensate for a deflection of distance 712 when viewing an object 718 relatively far from lens 702. An angle 720 represents an angle in which pan motor 202 and/or tilt motor 206 is rotated to compensate for a deflection of distance 712 when viewing object 718′ when it is relatively close to lens 702. In a case where angle 714 is a harmonic, angles 716 and 720 are also harmonic with the same frequency but having a different amplitude.

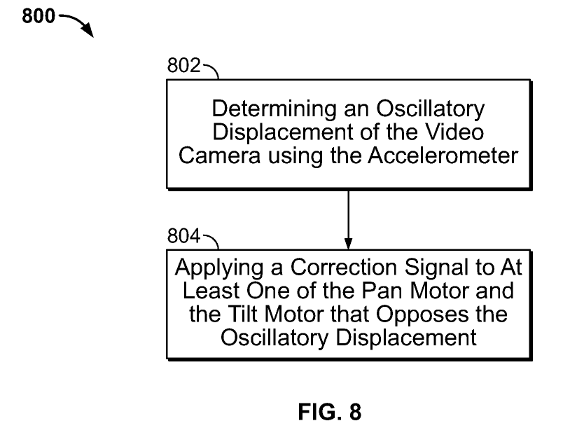

FIG. 8 is a flow chart of an exemplary method 800 of operating a video camera assembly that includes a video camera, an accelerometer, and at least one of a pan motor and a tilt motor. In the exemplary embodiment, method 800 includes determining 802 an oscillatory displacement of the video camera using the accelerometer, and applying 804 a correction signal to at least one of the pan motor and the tilt motor that opposes the oscillatory displacement. In an alternative embodiment, determining an oscillatory displacement of the video camera includes receiving acceleration data from the accelerometer, projecting the acceleration data to the video plane, phase shifting the projected data to generate a motor angular modulation signal, and applying the motor angular modulation signal to at least one of said pan motor and said tilt motor. In another alternative embodiment, method 800 further includes receiving video data from the video camera, determining a displacement vector using the video data, the displacement vector representing motion in the video data, determining a correlation of acceleration data received from the accelerometer and the displacement vector, and adjusting a gain of the correction signal using the correlation.

In a further alternative embodiment, adjusting a gain of the correction signal using the correlation includes leaving the gain unchanged if a correlation is not determined. In another alternative embodiment, method 800 includes resetting the correction signal when a field of view of the video camera is changed through direct zoom changes or pan/tilt position changes. In an alternative embodiment, determining an oscillation of the video camera assembly includes receiving a stream of images from the video camera, determining one or more motion vectors in the content of the received stream of images, and determining an oscillation of the video camera assembly using the determined motion vectors. In a further embodiment, determining one or more motion vectors in the content of the received stream of images includes determining a harmonic content of the determined motion vectors.

As will be appreciated based on the foregoing specification, the above-described embodiments of the invention may be implemented using computer programming or engineering techniques including computer software, firmware, hardware or any combination or subset thereof, wherein the technical effect is to determine oscillation characteristics of a security camera's installation and create a control algorithm that reduces the excitation of the oscillations. Any such resulting program, having computer-readable code means, may be embodied or provided within one or more computer-readable media, thereby making a computer program product, i.e., an article of manufacture, according to the discussed embodiments of the invention. The computer readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

The above-described embodiments of a video surveillance system provide a cost-effective and reliable means for determining characteristics of a security camera's installation and create a control algorithm that reduces the excitation of these natural frequencies.

Exemplary embodiments of video surveillance systems and apparatus are described above in detail. The video surveillance system components illustrated are not limited to the specific embodiments described herein, but rather, components of each system may be utilized independently and separately from other components described herein. For example, the video surveillance system components described above may also be used in combination with different video surveillance system components.

While the invention has been described in terms of various specific embodiments, it will be recognized that the invention can be practiced with modification within the spirit and scope of the claims.

1. A video camera assembly, comprising:
at least one of a pan motor rotatable about a pan axis and a tilt motor rotatable about a tilt axis;
a video camera coupled to said at least one of said pan motor and said tilt motor, said video camera is rotatable about at least one of the pan axis and the tilt axis, said video camera subject to an oscillatory displacement due to at least one of a vibrational excitation from a source external to said video camera assembly and a source internal to said video camera assembly;
an accelerometer coupled to said at least one of said pan motor and said tilt motor; and
a controller communicatively coupled to said at least one of said pan motor and said tilt motor, said controller further communicatively coupled to said accelerometer and said video camera, said controller configured to:
receive acceleration data from said accelerometer;
determine an oscillatory displacement of said video camera using the received acceleration data;
generate a motor angular modulation signal; and
apply the motor angular modulation signal to at least one of said pan motor and said tilt motor to reduce the oscillatory displacement of said video camera.

2. The video camera assembly of claim 1, wherein, said controller comprises a video acquisition processing path configured to:
acquire video data from the video camera;
determine oscillatory motion in the video data using differences in the video data between sequential frames of the video data;
generate a series of displacement vectors that indicate the frequency and phase of motion of the oscillatory motion;
normalize the displacement vectors to compensate for a distance to a physical object represented in the acquired video; and
weight the displacement vectors derived from a central portion of the frames of video data differently than the displacement vectors derived from a portion away from the central portion of the frames of video data.

3. The video camera assembly of claim 1, wherein, said controller comprises a position analyzer configured to:
receive video information from said video camera;
determine one or more motion vectors from the received video information;
determine harmonic oscillations in the determined motion vectors; and
apply a phase shifted correction signal to at least one of the pan motor and the tilt motor.

4. A method of operating a video camera assembly that includes a video camera, an accelerometer, and at least one of a pan motor and a tilt motor, said method comprising:
determining an oscillatory displacement of the video camera using the accelerometer; and
applying a correction signal to at least one of said pan motor and said tilt motor that opposes the oscillatory displacement.

5. The method of claim 4, wherein determining an oscillatory displacement of the video camera comprises:
receiving acceleration data from the accelerometer;
projecting the acceleration data to the video plane;
phase shifting the projected data to generate a motor angular modulation signal; and
applying the motor angular modulation signal to at least one of said pan motor and said tilt motor.

6. The method of claim 4, further comprising:
receiving video data from the video camera;
determining a displacement vector using the video data, the displacement vector representing motion in the video data;
determining a correlation of acceleration data received from the accelerometer and the displacement vector; and
adjusting a gain of the correction signal using the correlation.

7. The method of claim 6, wherein adjusting a gain of the correction signal using the correlation comprises leaving the gain unchanged if a correlation is not determined.

8. The method of claim 4, further comprising resetting the correction signal when a field of view of the video camera is changed through direct zoom changes or pan/tilt position changes.

9. The method of claim 4, wherein determining an oscillation of the video camera assembly comprises:
receiving a stream of images from the video camera;
determining one or more motion vectors in the content of the received stream of images; and
determining an oscillation of the video camera assembly using the determined motion vectors.

10. The method of claim 8, wherein determining one or more motion vectors in the content of the received stream of images comprises determining a harmonic content of the determined motion vectors.

11. A video system, comprising:
an enclosure comprising an accelerometer;
a video camera assembly positioned at least partially within said enclosure, said video camera assembly including a video camera and at least one of a pan mechanism and a tilt mechanism, said pan mechanism comprising a pan motor and a pan position encoder, said tilt mechanism comprising a tilt motor and a tilt position encoder; and
a controller communicatively coupled to said video camera assembly, said controller is configured to:
receive video data from said video camera;
analyze the video data from said video camera to determine differences between sequential frames of the video data;
determine displacement vectors from the analyzed video data, said displacement vectors representing a frequency and phase of motion of said video camera; and
transmit the determined displacement vectors to a gain adjustment module.

12. The video system of claim 11, wherein, said controller comprises a position analyzer configured to:
receive position information from at least one of said pan position encoder and said tilt position encoder;
determine residual oscillations in the position information during coasting of the video camera assembly;
determine a filter to apply to the at least one of the pan motor power signal and the tilt motor power signal to reduce excitation of the oscillation during normal operation.

13. The video system of claim 12, wherein, said controller is further configured to apply at least one of a notch filter and a band reject filter having a center frequency approximately equal to the determined oscillations.

14. The video system of claim 11, wherein, said controller comprises a position analyzer configured to:
receive video information from said video camera;
determine one or more motion vectors from the received video information;
determine harmonic oscillations in the determined motion vectors; and
apply a phase shifted correction to at least one of the pan motor power signal and the tilt motor power signal.

15. The video system of claim 11, wherein, said controller is further configured to:
generate an oscillation of the video camera assembly using at least one of the pan motor and the tilt motor;
deenergize power to the at least one of the pan motor and the tilt motor such that the video camera assembly coasts; and
analyze an output of the at least one of the pan axis encoder and the tilt axis encoder to determine oscillations of the video camera assembly during coasting.

16. The video system of claim 11, further comprising an acceleration data processing path that includes:
a low pass filter configured to reduce noise in the acceleration data acquired from said accelerometer;
a projection module configured to project the filtered acceleration data to a video plane;
a phase shifter configured to shift the phase of the projected data; and
transmit the phase shifted acceleration data to a gain adjustment module.

17. The video system of claim 16, wherein said phase shifter is configured to shift the phase of the projected data by approximately 180 degrees.

18. The video system of claim 16, wherein said phase shifter is configured to shift the phase of the projected data by an amount related to at least one of the magnitude and the phase of the acceleration data.

19. The video system of claim 16, wherein said gain adjustment module is configured to generate a motor angular modulation signal that when applied to at least one of the pan motor and the tilt motor tends to compensate for an oscillatory displacement of the video camera.

20. The video system of claim 16, wherein said phase shifted data is transmitted to a correlation module configured to adjust an amount of gain applied to a motor angular modulation signal using a correlation between the displacement vectors and the phase inverted acceleration data.
